(19) United States
(12) Patent Application Publication
(10) Pub. No.: US 2025/0170581 A1
(43) Pub. Date: May 29, 2025

(54) MOBILE AGGREGATE PROCESSING PLANT

(71) Applicant: Portafill International Limited, Dungannon (GB)

(72) Inventor: Malachy James RAFFERTY, Omagh (GB)

(73) Assignee: Portafill International Limited, Dungannon (GB)

(21) Appl. No.: 18/956,538

(22) Filed: Nov. 22, 2024

(30) Foreign Application Priority Data
Nov. 29, 2023 (GB) 2318237.1

(51) Int. Cl. B02C 23/02; B02C 21/02; B07B 1/00

(52) U.S. Cl. CPC B02C 23/02; B02C 21/02; B07B 1/005

(57) ABSTRACT

There is disclosed a mobile aggregate processing plant, including a mobile chassis, aggregate handling equipment mounted on the chassis, a first conveyor mounted on the chassis by an adjustable mounting support for movement between a transport position against the chassis and an operative position at a side of the chassis, characterised in that the mounting support is such that the first conveyor has a moveable centre of rotation relative to the chassis.

The overall width of the mobile aggregate processing plant can be reduced in the transport position to achieve a suitable transport configuration, and be extended to a larger number of operating configurations than hitherto, where there is no width restriction. Thus, the possible operating configurations available to the user are increased, increasing the user's working options for the plant.

### CROSS REFERENCE TO RELATED APPLICATIONS

This application claims priority benefit from Great Britain Application No. 2318237.1 filed on Nov. 29, 2023, entitled “Mobile Aggregate Processing Plant”, which is incorporated herein by reference in its entirety.

### FIELD OF THE INVENTION

The present invention relates to a mobile aggregate processing plant of the type comprising a mobile chassis with aggregate handling equipment, such as a crusher and screen for example, mounted on the chassis, and a conveyor for mounting at the side of the chassis.

### BACKGROUND TO THE INVENTION

Mobile aggregate processing plants are frequently used in quarries, building sites and the like, for crushing or comminating larger material such as quarried stone, or waste materials such as rubble from demolished buildings.

One example of a crusher is a jaw crusher. Jaw crushers are particularly suitable for, rough crushing at quarries, or crushing of waste or construction materials. According to the operating principle of a typical jaw crusher, crushing takes place against or between two jaws, typically one being fixed and one being a moving jaw. The material to be crushed is fed with an excavator or wheel loader to a feed hopper, from where the material falls into the throat of the jaw crusher, or a feeder transfers the rock material towards the jaw crusher. The material to be crushed may also be recyclable material, such as concrete, bricks, or asphalt.

Mobile aggregate processing plants are typically large and heavy. For example, they can have a height of more than 2 metres, a length of several metres, an operating width of 3 metres or more, and a weight of several tens of tonnes. Typically, a processing plant is manufactured, and then transported to each and every location where they are used. The mobile chassis provides some local or on site mobility, but it is not intended to be suitable for delivery of the processing plant, and for travelling on roads between locations or sites.

There are certain ‘transport’ width regulations or restrictions on the roads of many countries, such as the UK and Germany, such as 2550 mm, which restrict or affect the transport of larger mobile aggregate processing plants without special permits, which take time to obtain if obtainable.

In a conventional jaw crusher, an auxiliary conveyor can be removable from the chassis to allow for easier transportation, but this requires separate carriage of the conveyor. EP2883624A shows a mobile aggregate processing plant including a mobile chassis, and aggregate handling equipment mounted on the chassis, wherein a conveyor is mounted on the chassis by an adjustable mounting support for movement between a folded stored position against the chassis and an operative position at a side of the chassis. However, as processing plants get bigger, existing arrangements cannot be folded into a transport position that still suits many local traffic and road regulations

It is an object of the present invention to provide a mobile aggregate processing plant that can be bigger but still able to meet current road regulations to maintain transportability of the plant

### SUMMARY OF THE INVENTION

According to one object of the present invention, there is provided a mobile aggregate processing plant, including a mobile chassis, aggregate handling equipment mounted on the chassis, a first conveyor mounted on the chassis by an adjustable mounting support for movement between a transport position against the chassis and an operative position at a side of the chassis, characterised in that the mounting support is such that the first conveyor has a moveable centre of rotation relative to the chassis.

In this way, the first conveyor can be extended to a larger number of operating configurations than hitherto, where there is no width restriction. Thus, the possible operating configurations available to the user are increased, increasing the users' working options for the plant.

Optionally, the mounting support has a first centre of rotation with the chassis and a second parallel centre of rotation with the first conveyor. Two such centres of rotation provides a form of articulation, and also allow the transport or stored position of the first conveyor to put positioned in parallel with the chassis.

Optionally, the mounting support is connected at or near one end of the first conveyor. Optionally, the second end of the first conveyor is an outlet or output end, which is free to be directed outwardly at any angle relative to the chassis.

Optionally, the centre of rotation of the first conveyor is at or near one end of the first conveyor.

According to another object of the present invention, there is provided a mobile aggregate processing plant, including a mobile chassis, aggregate handling equipment mounted on the chassis, a first conveyor mounted on the chassis by an adjustable mounting support for movement between a transport position against the chassis and an operative position at a side of the chassis, characterised in that the operative position of the first conveyor is able to extend in an arc of more than 90° relative to the chassis.

In this way, the overall width of the mobile aggregate processing plant can be reduced in the transport position to achieve a suitable transport configuration, and be extended to a larger number of operating configurations than hitherto, where there is no width restriction. Thus, the possible operating configurations available to the user are increased, increasing the users' working options for the plant.

Optionally, the operative position of the first conveyor is able to extend in an arc of more than 150° relative to the chassis.

Optionally, the operative position of the first conveyor is able to extend in an arc of more than 180° relative to the chassis.

According to another object of the present invention, there is provided a mobile aggregate processing plant, including a mobile chassis, aggregate handling equipment mounted on the chassis, an aggregate material input end and at least one aggregate material output end creating a longitudinal material direction, and a first conveyor mounted on the chassis by an adjustable mounting support for movement between a transport position against the chassis, and an operative position extending from a side of the chassis, characterised in that the operative action of the first conveyor is able to move to be in line with or be contrary to the longitudinal material direction, or be at any angle thereinbetween.

In this way, the mobile aggregate processing plant can be extended to a larger number of operating configurations, including opposing positions facing forwardly or rearwardly, or even further.

Optionally, the mounting support comprises a cantilevered support arm for mounting the first conveyor on the chassis.

Optionally, the mounting support is operable to pivot the first conveyor about at least two rotational axes. Optionally, the two rotational axes are wholly or substantially parallel.

Alternatively, or additionally, the mounting support is articulated relative to the chassis to pivot the first conveyor.

In this way, the first conveyor part of the present invention is able to be manoeuvred to achieve a number of different discharge or re-circulating operations in use, using a ‘folding arm’ arrangement or system. The mounting support may comprise more than two axes, and axes at different relative directions, wherein articulated motion between the axes achieves at least the requirement of the present invention for the operative position of the first conveyor to be able to extend in an arc of more than 900 relative to the chassis from a transport position, and/or to move the first conveyor to be in line with or be contrary to the longitudinal material direction of the mobile aggregate processing plant, or be at any angle thereinbetween.

Optionally, the mounting support is pivotable about a first rotational axis with the chassis, and pivotable about a second rotational axis with the first conveyor. In this way, the mounting support provides double-axle articulation of movement for the first conveyor relative to the chassis.

Optionally, the least two rotational axes are parallel, so as to provide translational movement of the first conveyor relative to the chassis by the mounting support.

Optionally, the mounting support is operable to pivot the first conveyor from a transport position to an operable position using a first rotational axis, and is operable to pivot the first conveyor from one operable position to another operable position using a second rotational axis.

Optionally, the first conveyor is moveable from a transport position into an operative position in which an infeed end of the first conveyor is positioned for reception of aggregate material discharged from the aggregate handling equipment.

The mobile aggregate processing plant of the present invention may comprise one or more further primary and/or auxiliary conveyors. One or more further conveyors may be wholly or substantially fixed relative to the chassis. One or more further conveyors may be wholly or substantially internal relative to the chassis in comparison to the conveyor mounted on the chassis by an adjustable mounting support for movement between a transport or stored position against the chassis and an operative position. One or more further conveyors may be wholly or substantially in line with the longitudinal material direction of the plant, i.e. the general direction of material being treated by the plant. Typically, the longitudinal material direction of the plant is wholly or substantially the same as the longitudinal direction of the chassis. One or more further conveyors may be wholly or substantially transverse to the longitudinal material direction of the plant.

Thus, the present invention includes:
a mobile aggregate processing plant having a plurality of fixed conveyors relative to the chassis;
a mobile aggregate processing plant having at least one discharge conveyor, optionally being transverse to the longitudinal material direction of the plant;
a mobile aggregate processing plant having a plurality of conveyors wholly or substantially in line with the longitudinal material direction of the plant.

The skilled person can see that the present invention covers combination of the above embodiments, in addition to the first conveyor mounted on the chassis by an adjustable mounting support for movement between a transport position against the chassis, and an operative position extending outwardly from or at a side of the chassis.

For example, the present invention includes the embodiments comprising a mobile aggregate processing plant, including a mobile chassis, aggregate handling equipment mounted on the chassis, a first conveyor mounted on the chassis by an adjustable mounting support for movement between a transport position against the chassis and an operative position at a side of the chassis, and wherein either:
the mounting support is such that the first conveyor has a moveable centre of rotation relative to the chassis, and the operative position of the first conveyor is able to extend in an arc of more than 90° relative to the chassis, or
the mounting support is such that the first conveyor has a moveable centre of rotation relative to the chassis, and the operative action of the first conveyor is able to move to be in line with or be contrary to the longitudinal material direction, or be at any angle thereinbetween; or
the operative position of the first conveyor is able to extend in an arc of more than 90° relative to the chassis, and the operative action of the first conveyor is able to move to be in line with or be contrary to the longitudinal material direction, or be at any angle thereinbetween; or
the mounting support is such that the first conveyor has a moveable centre of rotation relative to the chassis, and the operative position of the first conveyor is able to extend in an arc of more than 90° relative to the chassis, and the operative action of the first conveyor is able to move to be in line with or be contrary to the longitudinal material direction, or be at any angle thereinbetween.

Optionally, mobile aggregate processing plant further comprises a discharge conveyor operable in a direction transverse to the longitudinal direction of the chassis, and able to provide the aggregate material discharged from the aggregate handling equipment onto the first conveyor.

Optionally, the first conveyor is moveable into an operative position wherein a discharge end of the first conveyor is positioned to discharge aggregate material to an inlet of the aggregate handling equipment. In this way, the first conveyor is moveable into a recirculating position in which an infeed end of the first conveyor is positioned for reception of aggregate material discharged from the aggregate handling equipment and a discharge end of the first conveyor is positioned to discharge aggregate material to an inlet of the aggregate handling equipment.

Optionally, the mounting support includes one or more actuating means for movement of the first conveyor. Various actuating means are known in the art, and are not limiting to the present invention. For example, ram and piston, or a swivel actuator.

Optionally, the mounting support includes a first actuating means and a second separate actuating means for movement of the first conveyor. For example, a first actuating means could be for movement of the conveyor about a first axis, and a second separate actuating means could be for movement of the first conveyor about a second axis.

Optionally, an inlet feed end of the first conveyor includes a funnel-shaped material collector. The funnel shaped collector may or may not be conical, including frusto-conical. The collector assist directing aggregate material processed by the mobile aggregate processing plant onto the feed end of the first conveyor.

The mobile aggregate processing plant may be for any form of treating or crushing or comminuting larger materials into one or more smaller aggregate streams. Such materials include quarried stone, or waste materials such as rubble from demolished buildings.

One example of a mobile aggregate processing plant is a crusher, such as a jaw crusher, impact crusher or cone washer, but the invention is not limited thereto. Other mobile aggregate processing plants able to include the present invention include those with screens.

Optionally, the aggregate handling equipment includes an infeed hopper, an aggregate processor such as a crusher, mounted at an outlet of the infeed hopper, a discharge conveyor mounted at an outlet of the processor, a screen mounted at an outlet of the discharge conveyor, a screen discharge conveyor mounted at an outlet of the screen, a discharge end of the screen discharge conveyor feeding at least an infeed hopper at an infeed end of the first conveyor.

According to another object of the present invention, there is provided a method of moving a first conveyor mounted on the chassis of a mobile aggregate processing plant, the plant including the mobile chassis, aggregate handling equipment mounted on the chassis, and an adjustable mounting support for the first conveyor, the method comprising at least the steps of:
moving the first conveyor at or near one end of the first conveyor from a transport position to an operable position; and
moving the first conveyor at or near one end of the first conveyor from one operable position to another operable position.

According to another object of the present invention, there is provided a method of moving a first conveyor mounted on the chassis of a mobile aggregate processing plant, the plant including the mobile chassis, aggregate handling equipment mounted on the chassis, and an adjustable mounting support for the first conveyor, the mounting support having a first centre of rotation with the chassis and a second parallel centre of rotation with the first conveyor, the method comprising at least the steps of:
moving the first centre of rotation to pivot the first conveyor (5) from a transport position to an operable position; and
moving the second centre of rotation to pivot the first conveyor (5) from one operable position to another operable position.

According to another object of the present invention, there is provided a method of moving a first conveyor mounted on the chassis of a mobile aggregate processing plant, the plant including the mobile chassis, aggregate handling equipment mounted on the chassis, and an adjustable mounting support for the first conveyor, the method comprising at least the steps of:
moving the adjustable mounting support to move the first conveyor between a transport position against the chassis, and an operative position extending from a side of the chassis in an arc of more than 90° relative to the chassis.

According to another object of the present invention, there is provided a method of moving a first conveyor mounted on the chassis of a mobile aggregate processing plant, the plant including the mobile chassis, aggregate handling equipment mounted on the chassis, an aggregate material input end and at least one aggregate material output end creating a longitudinal material direction, and an adjustable mounting support for the first conveyor, the method comprising at least the steps of:
moving the adjustable mounting support to move the first conveyor between a transport position against the chassis, and an operative position that is in line with or is contrary to the longitudinal material direction, or be at any angle thereinbetween.

### BRIEF DESCRIPTION OF THE DRAWINGS

The invention will be more clearly understood by the following description of some embodiments thereof, given by way of example only with reference to the accompanying drawings, in which:

FIG. 1 is a perspective view of a mobile aggregate processing plant according to the one embodiment of the present invention;

FIGS. 2a, 2b and 2c are rear perspective, forward perspective and plan drawings respectively of a screen unit and a first conveyor of an embodiment of the present invention, in a transport position, in accordance with an aspect of the present disclosure;

FIGS. 3 and 4 are plan and forward perspective drawings respectively of a screen unit and a first conveyor of an embodiment of the present invention, in one operating position, in accordance with an aspect of the present disclosure;

FIG. 5 is an exploded view of circle A in FIG. 4, in accordance with an aspect of the present disclosure;

FIGS. 6a, 6b and 6c are rear perspective, forward perspective and plan drawings respectively of a screen unit and a first conveyor of an embodiment of the present invention, in a second operating position, in accordance with an aspect of the present disclosure; and

FIGS. 7a and 7b are side and plan views of a mobile aggregate processing plant according to the invention showing transport dimensions, in accordance with an aspect of the present disclosure.

### DETAILED DESCRIPTION FOR CARRYING OUT THE INVENTION

Mobile aggregate processing plants are frequently used in quarries, building sites and the like, for crushing or comminuting larger material such as quarried stone, or waste materials such as rubble from demolished buildings.

Mobile aggregate processing plants are typically large and heavy. For example, they can have a height of more than 2 metres, a length of several metres, an operating width of 3 metres or more, and a weight of several tens of tonnes. Typically, a processing plant is manufactured, and then transported to each and every location where they are used. The mobile chassis provides some local or on site mobility, but it is not intended to be suitable for delivery of the processing plant, and for travelling on roads between locations or sites.

There are certain ‘transport’ width regulations or restrictions on the roads of many countries, such as the UK and Germany, such as 2550 mm, which restrict or affect the transport of larger mobile aggregate processing plants without special permits, which take time to obtain if obtainable.

The present invention provides a mobile aggregate processing plant, including a mobile chassis, aggregate handling equipment mounted on the chassis, a first conveyor mounted on the chassis by an adjustable mounting support for movement between a transport position against the chassis and an operative position at a side of the chassis, characterised in that the mounting support is such that the first conveyor has a moveable centre of rotation relative to the chassis.

In this way, the overall width of the mobile aggregate processing plant can be reduced by the mounting support in a transport position to achieve a suitable transport configuration, and be extended to a larger number of operating configurations than hitherto, where there is no width restriction. Thus, the possible operating configurations available to the user are increased, increasing the user's working options for the plant.

Bespoke transport typically requires exceptional transport costs and/or permissions, in particular transport permits, which may be required from a number of different authorities if the plant is intended to cross a number of authority boundaries.

The present invention can take advantage of the current road regulations, to alter the overall width of the mobile aggregate processing plant between an acceptable transport configuration not requiring special permits of the like, and a number of operating configurations, particularly a number of operating positions not previously possible, extending the range of operating positions available to a user. Reducing the width of the mobile aggregate processing plant in a transport position allows the mobile aggregate processing plant to meet certain transport width regulations or restrictions.

In the way, the present invention can allow heavier and/or larger sized mobile aggregate processing plants, or mobile aggregate processing plants having larger aggregate processing equipment, to still be conveniently transported from place to place. For example, a heavier and/or larger crusher can aggregate a larger range of feed material, and so be useable across a greater range of sites without requiring the conventional additional transport permits. In particular, the present invention allows for a mobile aggregate processing plant with a heavier and/or larger crusher to be transported along public highways or rail etc., within the same width regulations or restrictions. For example, the usual road transport width is 2550 mm, so that the present invention can transport mobile aggregate processing plants which may have an operational overall width of over 2550 m, but which can have a transport width of 2550 mm or less.

The present invention at least also provides a mobile aggregate processing plant, including a mobile chassis, aggregate handling equipment mounted on the chassis, a first conveyor mounted on the chassis by an adjustable mounting support for movement between a transport position against the chassis and an operative position at a side of the chassis, characterised in that the operative position of the first conveyor is able to extend in an arc of more than 90° relative to the chassis.

The present invention at least also provides a mobile aggregate processing plant, including a mobile chassis, aggregate handling equipment mounted on the chassis, an aggregate material input end and at least one aggregate material output end creating a longitudinal material direction, and a first conveyor mounted on the chassis by an adjustable mounting support for movement between a transport position against the chassis, and an operative position extending from a side of the chassis, characterised in that the operative action of the first conveyor is able to move to be in line with or be contrary to the longitudinal material direction, or be at any angle thereinbetween.

The skilled person can see how one or more of the above embodiments or arrangements can be combined.

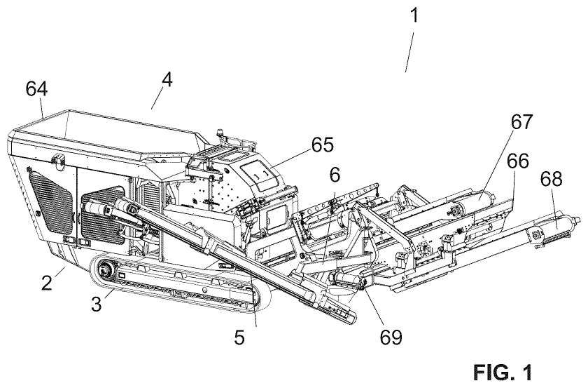

Referring to the drawings, FIG. 1 shows a mobile aggregate processing plant according to the invention indicated generally by the reference numeral 1. The mobile aggregate processing plant 1 comprises a mobile chassis 2 which in this case is mounted on tracks 3. Aggregate handling equipment, indicated generally by the reference numeral 4, is mounted on the chassis 2.

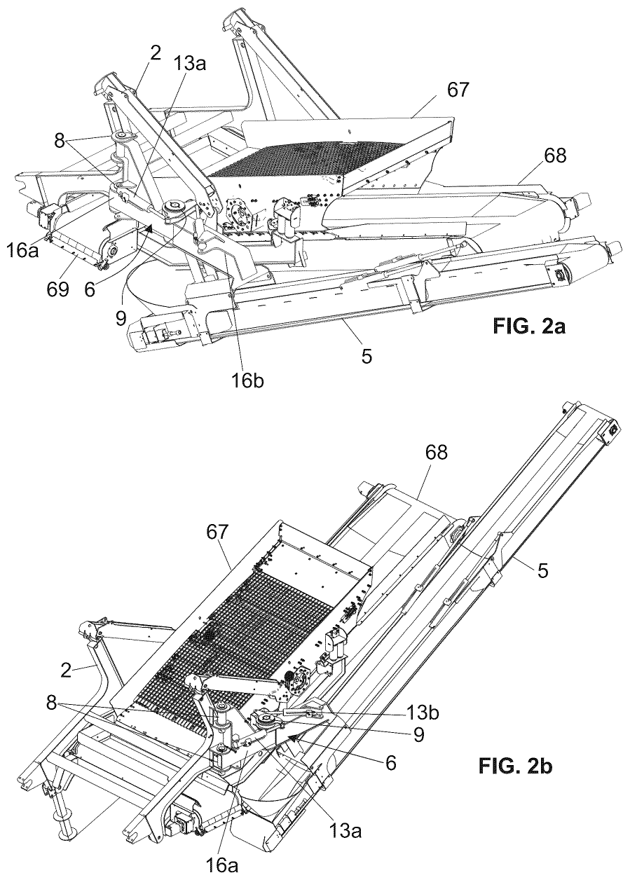

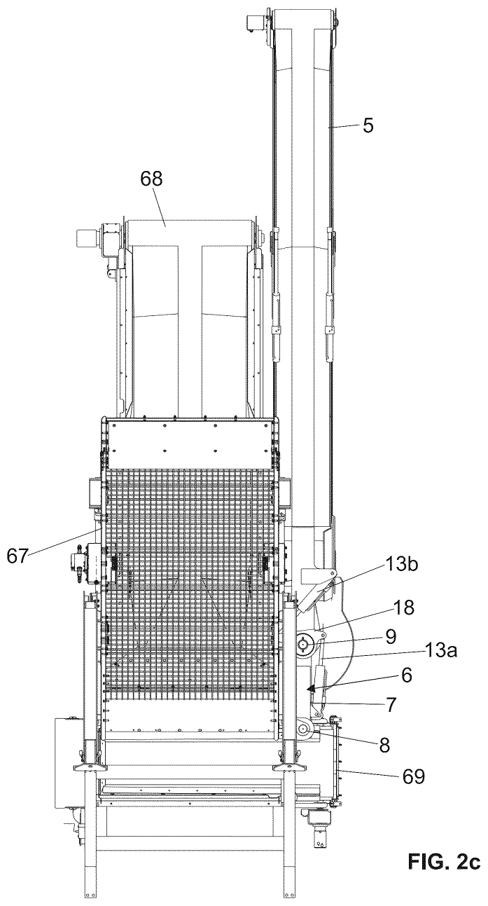

In accordance with an embodiment of the present invention, a first conveyor 5 mounted on the chassis by an adjustable mounting support 6, and is movable between a stored position against one side of the chassis 2 and a number of deployed operative positions at a side of the chassis 2, as shown in FIG. 2 onwards for example, and described in more detail later.

The aggregate handling plant 1 also comprises an infeed hopper 64 mounted on the chassis 2. A crusher 65 is mounted on the chassis 2 at an outlet of the infeed hopper 64. A discharge first conveyor 66 is mounted at an outlet of the crusher 65 for delivery of material from the crusher 65 to a screen 67. Material of the desired size will fall through the screen 67 onto a first discharge conveyor 68 for delivery to a stockpile for example. Oversized material is delivered from the screen 67 onto a second discharge conveyor 69, which can discharge oversized material laterally onto the first conveyor 5. When the first conveyor 5 is in a recirculation position as described hereinafter, such oversized material can be passed back into the infeed hopper 64 for recirculation through the crusher 65.

FIGS. 2a, 2b and 2c show different views of a portion of the plant 1 shown in FIG. 1, in particular the screen 67, the adjustable mounting support 6, and the first conveyor 5.

FIGS. 2a, 2b and 2c show the first conveyor 5 in a transport position, whereby the first conveyor 5 is in line with the longitudinal material direction of material being treated by the plant from the feed end. The longitudinal material direction is generally being from the end of the plant 1 with a hopper such as the hopper 64 shown in FIG. 1, and one or more discharge outlets or locations, such as being the end of one or more of the in-line conveyors, in particular the discharge conveyor 68.

FIGS. 2a, 2b and 2c show the mounting support 6 comprising a cantilevered support arm 7 for mounting the first conveyor 5 on the chassis 2, (shown only as the part of the frame supporting the screen 67). The cantilevered support arm 7 can either be directly mounted to the chassis, or fixed to the chassis through one or more frames or sub-frames. The cantilevered support arm 7 has a chassis end 16a and a firs distal end 16b

FIGS. 2a, 2b and 2c show the mounting support 6 able to pivot the first conveyor 5 about at least two rotational axes 8, 9. A first rotational axis 8 can be provided between the cantilevered support arm 7 and the chassis 2 at or near one end 16a of the cantilevered support arm 7, optionally through one or more shafts and pins (two shown in FIGS. 2a-c). A second rotational axis 9 can be arranged at or near the distal end 16b of the cantilevered support arm 7, to be pivotable between the cantilevered support arm 7 and the first conveyor 5. In this way, the first conveyor 5 has a centre of rotation about the second axis 9 that is moveable relative to the chassis 2.

In the example shown in FIGS. 2a, 2b and 2c, actuating means are used for movement of the first conveyor 5 relative to the chassis 2. In particular, FIGS. 2a, 2b and 2c show a first actuating means 13a being a ram and piston, and a second separate actuating means 13b, also being a ram and piston. The first actuating means 13a is able to operate movement of the mounting support 6 relative to the chassis 2, and the second actuating means 13b is able to actuate movement of the first conveyor 5, attached to the other end of the mounting support 6, relative to the chassis 2, and the mounting support 6. Optionally, the first and second actuating means 13a, 13b operate on, against, or otherwise through a plate 18 aligned with the second rotational axis 9.

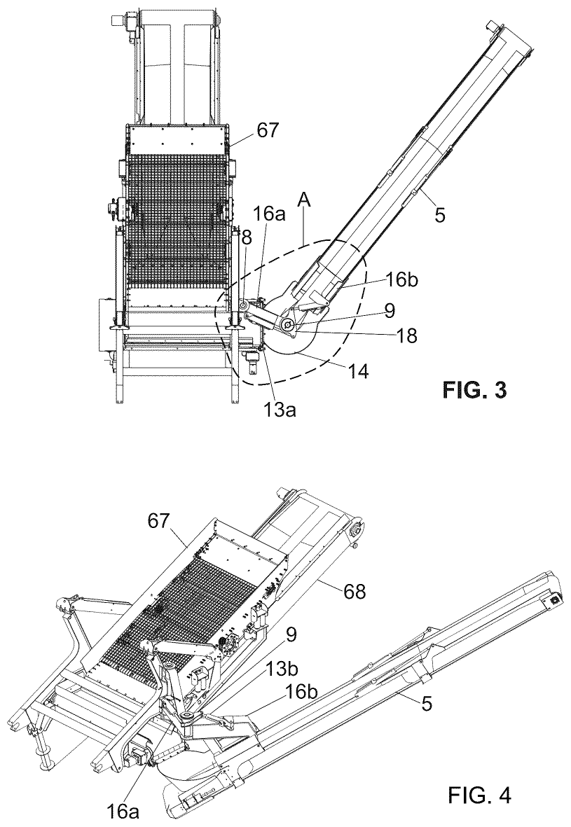

FIG. 3 is a plan view of the same screen unit 67, mounting support 6 and first conveyor 5 of FIGS. 2a, 2b and 2c, showing the first conveyor 5 moved in an arc away from the chassis 2 and screen 67, and into a first angle relative thereto. Such first angle could represent a first working or operative position of the first conveyor 5. The skilled person can see that the first angle can be any one of a number of angles relative to the longitudinal general direction and longitudinal material direction of the chassis 2 of the plant 1, such that the present invention can provide an operative position of the first conveyor 5 extending in an arc of more than 90° relative to the chassis 2.

The first position shown in FIG. 3 is at an angle such that discharge from the second discharge conveyor 69 can pass onto a feed or inlet end of the first conveyor 5. FIG. 3 also shows the inlet end of the first conveyor 5 including a funnel shape material collector 14, to assist guided transfer of discharge material from the second discharge conveyor 69 onto the feed end or inlet end of the first conveyor 5.

FIG. 4 is a perspective view of the same screen 67, mounting support 6 and first conveyor 5 as shown in FIG. 3.

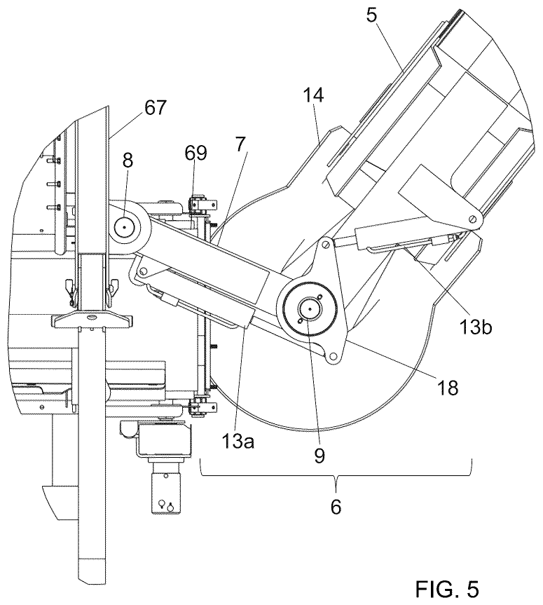

FIG. 5 is an enlarged portion A of FIG. 3, showing in more detail the first rotational axis 8, the first actuating means 13a, the second rotational axis 9, and the second actuating means 13b. FIG. 5 also shows a plate 18 located along the second rotational axis 9, to which the ram ends of the first actuating means 13a and second actuating means 13b are attached. In this way, coordinated movement of the first conveyor 5 is possible relative to the chassis 2, to move the first conveyor 5 between the tucked in transport position against the chassis shown in FIGS. 2a-2c, and any number of arcuate operative positions extending from a side of the chassis, such as the one shown in FIGS. 3, 4 and 5. FIG. 5 also shows the discharge end of the second discharge 69 able to discharge material in use into the funnel 14 for the passage of material onto the feed end of the first conveyor 5.

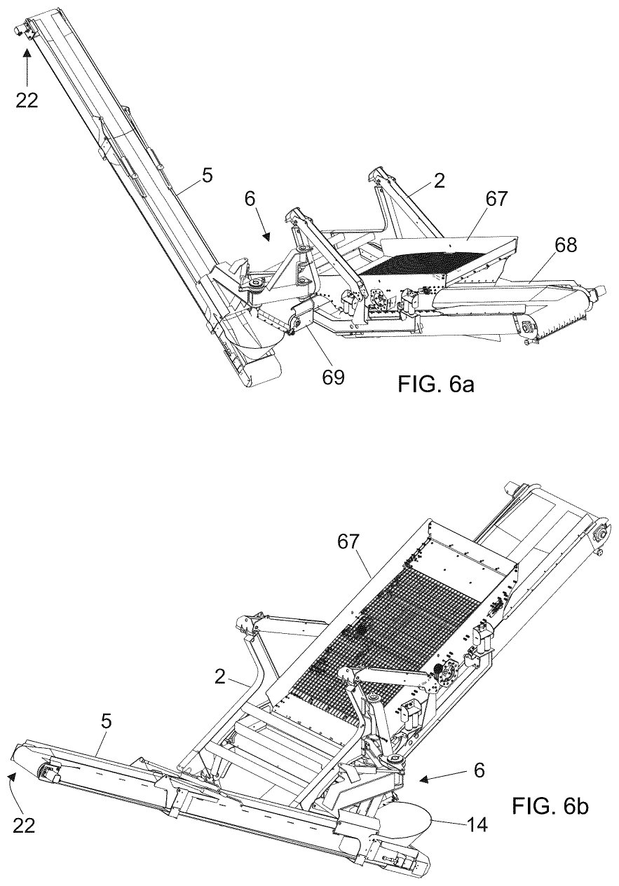

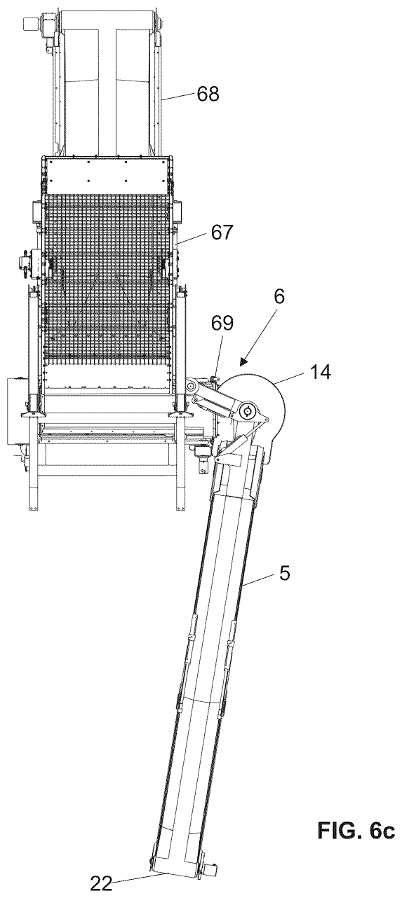

FIGS. 6a, 6b and 6c show rear perspective, forward perspective, and plan drawings respectively of the screen unit 67 on part of the chassis 2 of a mobile aggregate processing plant 1 as shown in FIG. 1, with the same mounting support 6 and first conveyor 5. The first conveyor 5 is now in a further operative position relative to the chassis 2, in particular wherein it is able to have a discharge end 22 positioned to discharge aggregate material into or towards an inlet of the aggregate handling equipment 4 (not shown). Such an inlet may be the feed hopper 64 shown in the plant 1 in FIG. 1, to achieve recirculation of material not fully processed by the plant 1. Thus, FIGS. 6a-6c show an operative ‘recirculation’ position for the first conveyor 5, which is now more than 180° from the transport position shown in FIGS. 2a-2c.

Thus, FIGS. 2-6 show a mobile aggregate processing plant having a first conveyor 5 mounted on the chassis 2 by an adjustable mounting support 6, for movement between a transport position against the chassis, and an operative position extending away from a side of the chassis, characterised in that the operative position of the first conveyor 5 is able to extend in an arc of more than 90° relative to the chassis, in particular in an arc of more than 150°, and more particularly in an arc of more than 180° relative to the chassis.

Use of the first and second actuating means 13a, 13b provides a method of moving a first conveyor 5 mounted on the chassis 2 of a mobile aggregate processing plant, the plant including the mobile chassis, aggregate handling equipment 4 mounted on the chassis 2, and an adjustable mounting support 6 for the first conveyor 5, the mounting support 6 having a first centre of rotation with the chassis 2 and a second parallel centre of rotation with the first conveyor 5, the method comprising at least the steps of moving the first centre of rotation to pivot the first conveyor 5 from a transport position to an operable position, and moving the second centre of rotation to pivot the first conveyor from one operable position to another operable position.

Use of the first and second actuating means 13a, 13b also provides a method of a method of moving a first conveyor 5 mounted on the chassis 2 of a mobile aggregate processing plant, the plant including the mobile chassis, aggregate handling equipment 4 mounted on the chassis, and an adjustable mounting support 6 for the first conveyor, the method comprising at least the step of moving the adjustable mounting support to move the first conveyor 5 between a transport position against the chassis 2, and an operative position extending from a side of the chassis in an arc of more than 90° relative to the chassis.

Use of the first and second actuating means 13a, 13b also provides a method of moving a first conveyor 5 mounted on the chassis 2 of a mobile aggregate processing plant 1, the plant 1 including the mobile chassis 2, aggregate handling equipment 4 mounted on the chassis 2, an aggregate material input end and at least one aggregate material output end creating a longitudinal material direction, and an adjustable mounting support 6 for the first conveyor 5, the method comprising at least the step of moving the adjustable mounting support 6 to move the first conveyor between a transport position against the chassis 2, and an operative position that is in line with or is contrary to the longitudinal material direction, or be at any angle thereinbetween.

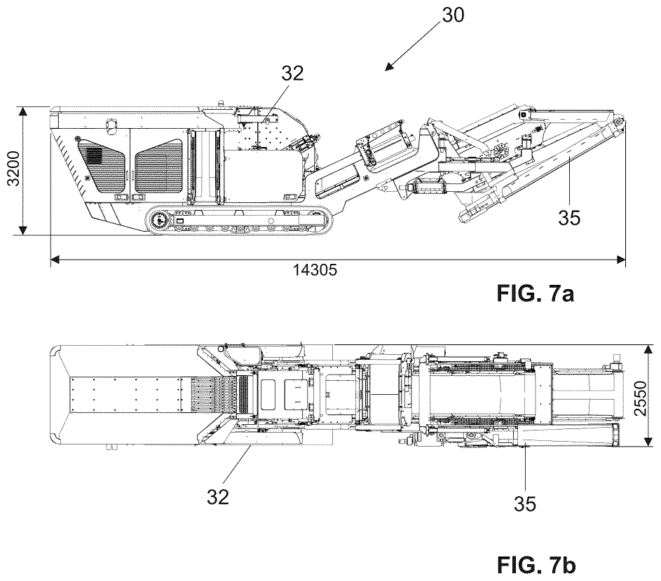

FIGS. 7a and 7b shows side and planned views of a mobile aggregate processing plant according to another embodiment of the present invention and indicated generally by the reference numeral 30. FIGS. 7a and 7b give typical dimensions for the plant 30 having a first conveyor 35, which first conveyor is in a transport position against the chassis 32 of the plant 30. FIG. 7b confirms an overall width of the plant 30 being 2550 mm within the general road regulations of many European countries at least, allowing the mobile aggregate processing plant 30 of the present invention to be directly transported by road to different sites without requiring special permission or special permit.

It will be appreciated that in the mobile aggregate processing plant of the invention, the arrangement of the mounting support firstly mounts the first conveyor on the chassis 2, allowing movement of the first conveyor between a transport position against the chassis and various deployed operative positions. Further the mounting support provides great flexibility in the movement and positioning of the first conveyor into a number of different operating positions on the chassis. As the first conveyor is mounted on the chassis the mobile aggregate processing plant is self-contained and fully operational without the need for separate lifting gear to mount/demount the first conveyor.

The examples and embodiments of the present invention show the use of the first conveyor of the mobile aggregate processing plant being a returns conveyor, able to return processed material back into an inlet or feed of the plant, as well as a stock piling conveyor or discharge conveyor, able to pass the same such material to one or more alternative locations or stock piling places or other collectors or transport.

The present invention is able to act independently of any processing conveyors related to the aggregate handling process, portion or equipment of the mobile aggregate processing plant, and in particular the discharge conveyors and arrangements of material from the handling equipment.

The skilled man can also see how the first conveyor described herein is useable in mobile aggregate plants and machinery being able to aggregate or process material beyond being a crusher or crushing plant. The first conveyor part of the present invention can be attached to other mobile aggregate processing plants, such as jaw crushers, impact crushers, cone washers, and mobile aggregate processing plants having various screens, for use therewith in a manner as described above, in particular being able to extend to one or more operative positions in an arc of more than 90° relative to the chassis, and optionally more than 150°, or even 180° relative to the chassis.

As may be recognized by those of ordinary skill in the art based on the teachings herein, numerous changes and modifications may be made to the above-described and other embodiments of the present disclosure without departing from the scope of the disclosure. The components of the mobile aggregate processing plant as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the mobile aggregate processing plant may include more or fewer components or features than the embodiments as described and illustrated herein. Further, the steps of the method of moving a first conveyor mounted on the chassis may be used interchangeably and in alternative combinations as would be modified or altered by one of skill in the art. Accordingly, this detailed description of the currently-preferred embodiments is to be taken as illustrative, as opposed to limiting of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or the plant that “comprises,” “has,” “includes,” or “contains” one or more steps or elements possesses those one or more steps or elements, but is not limited to possessing only those one or more steps or elements. Likewise, a step of a method or an element of a plant that “comprises,” “has,” “includes,” or “contains” one or more features possesses those one or more features, but is not limited to possessing only those one or more features. Furthermore, a plant or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

1. A mobile aggregate processing plant, including a mobile chassis, aggregate handling equipment mounted on the chassis, an aggregate material input end and at least one aggregate material output end creating a longitudinal material direction, and a first conveyor mounted on the chassis by an adjustable mounting support for movement between a transport position against the chassis, and an operative position extending from a side of the chassis,
characterised in that the mounting support is such that the first conveyor has a moveable centre of rotation relative to the chassis.

2. The mobile aggregate processing plant as claimed in claim 1, wherein the wherein the mounting support has a first centre of rotation with the chassis and a second parallel centre of rotation with the first conveyor.

3. The mobile aggregate processing plant as claimed in claim 1, wherein the mounting support is connected at or near one end of the first conveyor.

4. The mobile aggregate processing plant as claimed in claim 1, wherein the centre of rotation of the first conveyor is at or near one end of the first conveyor.

5. The mobile aggregate processing plant as claimed in claim 1, wherein the mounting support comprises a cantilevered support arm for mounting the first conveyor on the chassis.

6. The mobile aggregate processing plant as claimed in claim 1, wherein the mounting support is operable to pivot the first conveyor about at least two rotational axes.

7. The mobile aggregate processing plant as claimed in claim 6, wherein the mounting support is pivotable about a first rotational axis with the chassis, and pivotable about a second rotational axis with the first conveyor.

8. The mobile aggregate processing plant as claimed in claim 7, wherein the least two rotational axes are parallel.

9. The mobile aggregate processing plant as claimed in claim 7, wherein the mounting support is operable to pivot the first conveyor from a transport position to an operable position using a first rotational axis, and is operable to pivot the first conveyor from one operable position to another operable position using a second rotational axis.

10. The mobile aggregate processing plant as claimed in claim 1, wherein the first conveyor is moveable from a transport position into an operative position in which an infeed end of the first conveyor is positioned for reception of aggregate material discharged from the aggregate handling equipment.

11. The mobile aggregate processing plant (1) as claimed in claim 10 further comprising a discharge conveyor (69) operable in a direction transverse to the longitudinal direction of the chassis (2), and able to provide the aggregate material discharged from the aggregate handling equipment (4) onto the first conveyor (5).

12. The mobile aggregate processing plant as claimed in claim 1, wherein the first conveyor, is moveable into an operative position wherein a discharge end of the first conveyor is positioned to discharge aggregate material to an inlet of the aggregate handling equipment.

13. The mobile aggregate processing plant as claimed in claim 1, wherein the mounting support, includes one or more actuating means for movement of the first conveyor.

14. The mobile aggregate processing plant as claimed in claim 13, wherein the mounting support includes a first actuating means and a second separate actuating means for movement of the first conveyor (5).

15. The mobile aggregate processing plant as claimed in claim 1, wherein an inlet feed end of the first conveyor includes a funnel-shaped material collector.

16. A mobile aggregate processing plant, including a mobile chassis, aggregate handling equipment mounted on the chassis, and a first conveyor mounted on the chassis by an adjustable mounting support for movement between a transport position against the chassis, and an operative position extending from a side of the chassis,
characterised in that the operative position of the first conveyor is able to extend in an arc of more than 90° relative to the chassis.

17. The mobile aggregate processing plant as claimed in claim 16, wherein the operative position of the first conveyor is able to extend in an arc of more than 180° relative to the chassis.

18. A mobile aggregate processing plant, including a mobile chassis, aggregate handling equipment mounted on the chassis, an aggregate material input end and at least one aggregate material output end creating a longitudinal material direction, and a first conveyor mounted on the chassis by an adjustable mounting support for movement between a transport position against the chassis, and an operative position extending from a side of the chassis,
characterised in that the operative position of the first conveyor is able to move to be in line with or be contrary to the longitudinal material direction, or be at any angle thereinbetween.

19. A method of moving a first conveyor mounted on the chassis of a mobile aggregate processing plant, the plant including the mobile chassis, aggregate handling equipment mounted on the chassis, and an adjustable mounting support for the first conveyor, the mounting support having a first centre of rotation with the chassis and a second parallel centre of rotation with the first conveyor, the method comprising at least the steps of:
moving the first centre of rotation to pivot the first conveyor from a transport position to an operable position; and
moving the second centre of rotation to pivot the first conveyor from one operable position to another operable position.

20. A method of moving a first conveyor as claimed in claim 19 further comprising moving the adjustable mounting support to move the first conveyor between a transport position against the chassis, and an operative position extending from a side of the chassis in an arc of more than 90° relative to the chassis.
